(19) United States
(12) Patent Application Publication
(10) Pub. No.: US 2008/0203308 A1
(43) Pub. Date: Aug. 28, 2008

(54) CAR SIDE MIRROR EQUIPPED WITH THERMAL INFRARED CAMERA

(76) Inventor: Sang Keun YOO, Daejeon (KR)

Correspondence Address: BIRCH STEWART KOLASCH & BIRCH, PO BOX 747, FALLS CHURCH, VA, 22040-0747, US

(21) Appl. No.: 12/034,466

(22) Filed: Feb. 20, 2008

(30) Foreign Application Priority Data
Feb. 28, 2007 (KR) 10-2007-20259

(51) Int. Cl. G01J 5/04

(52) U.S. Cl. 250/352

(57) ABSTRACT

Disclosed herein is a car side mirror equipped with a thermal infrared camera. The car side mirror includes a thermal infrared camera device, a video signal transmission device, a power unit. Associated with the side mirror device is a display device inside the car. The thermal infrared camera device includes a thermal image sensor for receiving infrared signals, an electronic circuit for determining whether an obstacle exists in front of a car, and containing an individual Identification (ID), and a video output unit for converting output signals into video signals. The thermal infrared camera device photographs one or more objects in a desired direction. The video signal transmission device transmits the video signals to a display device. The power unit supplies power to the thermal infrared camera device and the video signal transmission device. The display device identifies the individual ID of the thermal infrared camera and then receives the video signals.

### BACKGROUND OF THE INVENTION

1. Field of the Invention

The present invention relates generally to a car side mirror equipped with a thermal infrared camera and, more particularly, to a car side mirror in which a small thermal infrared camera device and a microstrip antenna are installed, thereby enabling the monitoring of objects in front of the car.

2. Description of the Related Art

Generally, people make driving decisions while viewing the road ahead using the naked eye with the assistance of external illumination, such as ambient light or the light from headlights. However, when driving in fog or at night, the risk of a traffic accident is increased compared to a well lit roadway, since it can be difficult to see and recognize objects with sufficient time for drivers using only the naked eye.

Accordingly, the use of electronic equipment to assist in and to augment the driver's vision capabilities in cases of poor visibility is desirable.

Thermal infrared cameras detect light in a wavelength band of 7,000˜14,000 nm, which is about 20 times as longer than light in the visible wavelength band of 400˜780 nm. Thermal infrared light has the ability to pass through fog unimpeded and thus significantly increases the object recognition distance compared to unaided situations. Additionally, headlamp brightness is limited by law to prevent blinding of oncoming drivers and thus limits the effective distance that these can be used to see further up the road, whereas thermal infrared light uses the light emitted by the objects in the roadway and thus increases the probability of seeing these objects further up the road as well. If these characteristics of the thermal infrared light is employed, more effective observation is enabled in driving situations in which illumination conditions are poor, such as a in fog or at nighttime. Such thermal infrared cameras ensure visible distances that are about 3˜5 times as far as visible distances that can be provided by existing car illumination.

However, thermal infrared rays are not able to penetrate the glass of a typical car, such as a windshield, and this limits the locations for installation of a thermal infrared camera.

FIG. 1 is a diagram showing the appearance of a car equipped with a prior art infrared camera device, and FIG. 2 is a block diagram showing the infrared camera device of FIG. 1.

As shown in FIGS. 1 and 2, the prior art infrared camera device includes an infrared camera 301 mounted on a bumper 302, directed forward and configured to detect heat, an infrared emitter 303 configured to emit infrared rays, a sensor driving unit 802 configured to electrically drive the infrared sensor 303, a received signal detection unit 801 for receiving infrared signals radiated from objects, a microprocessor 803 for receiving the results of the detection of the received signal detection unit 801 which then determines whether an obstacle is present in front of a car, and a video output unit 804 for enabling the video signals and video information extraction signals of the microprocessor 803 to be displayed on a display inside the car. Meanwhile, depending on the imaging element technology used in the infrared sensor 303 for the acquisition of images, a mechanical chopper (for example, used with a ferroelectric device) or a shutter (for example, a microbolometer) may be employed.

However, in the case of existing cars sold with no thermal infrared cameras provided, the bumpers 302 thereof are not prepared for the mounting of the infrared cameras 301, so that, when retrofitting thermal infrared cameras, various mechanical, thermal and electrical problems are encountered, and additional expenses for mounting the thermal infrared cameras on the bumpers 302 are incurred because a power supply line and a signal input line are not provided to the bumpers 302a at desired locations.

Furthermore, since the bumper 302 is configured to reduce impact when a car collides with or comes into contact with another car, it is not appropriate to mount an electronically/mechanically precise thermal infrared camera device at a location at which impacts are expected to be applied. Furthermore, once an accident occurs and the bumper is damaged, the entire bumper must be replaced with a new one, and the new bumper must be re-modified to accept the thermal infrared camera so that the financial burden is large.

Moreover, since the size of a bumper is large, logistics costs are high.

Moreover, even if a car maker first installs a thermal infrared camera device on a bumper, there occur various problems such as the problem of removing and reinstalling the bumper, which is massive, at the time of the repair. In the case where an existing bumper 302 is modified to mount a thermal infrared camera device thereon, a problem occurs in that high development costs for a large-sized mold are incurred.

### SUMMARY OF THE INVENTION

Accordingly, the present invention has been made keeping in mind the above problems occurring in the prior art. An object of the present invention is to provide a car side mirror equipped with a thermal infrared camera, which enables a thermal infrared camera device to be easily installed in a car side mirror using only an existing power supply line, signal line and the internal vacant space of the side mirror without deploying an additional power supply lines and signal lines.

By doing so, the car side mirror equipped with the thermal infrared camera according to the present invention can be easily installed separately and can transmit video information to a display device inside a car using radio communication technology such as Bluetooth, so that separate wiring work is not required, and thus the mounting thereof is simplified, thereby considerably reducing expenses for the installation of a thermal infrared camera device.

Meanwhile, when radio communication is expensive or is difficult to perform, a car side mirror integrated with a thermal infrared camera device, which is capable of transmitting video information and command information via an existing signal line, is provided. Of course, a separate signal line may be deployed and used in this case if needed. If a method such as Power Line Communication (PLC) is exploited, communication using a power line is enabled without the addition of a separate signal line.

Another object of the present invention is to provide a car side mirror equipped with a thermal infrared camera, in which, in order to prevent the theft of the car side mirror, an encryption technique is applied to a thermal infrared camera device and a display device inside a car, and the operation of the thermal infrared camera device is prevented by preventing video signals and command signals from being normally transmitted in the case where the side mirror equipped with the thermal infrared camera is separated from the car and is installed in another car, thereby reducing the likelihood of theft of the car side mirror.

In order to accomplish the above object, the present invention provides a car side mirror equipped with a thermal infrared camera device, including:

a thermal infrared camera device, comprising a thermal image sensor for receiving thermal infrared light signals, an electronic circuit for determining whether an obstacle exists in front of a car using thermal signals that have passed through the thermal image sensor, and containing individual Identification (ID), and a video output unit for converting output signals of the electronic circuit into video signals, the thermal infrared camera device being attached to the front surface of a side mirror member and photographing one or more objects in a desired direction;

a video signal transmission device for transmitting the video signals, acquired through the photographing of the thermal infrared camera device, to a display device inside the car;

a power unit for supplying power to the thermal infrared camera device and the video signal transmission device; and

a display device for identifying the individual ID of the thermal infrared camera and then receiving the video signals.

Furthermore, the thermal infrared camera device includes a thermal image sensor for detecting thermal signals emitted from an object in front of a car, a mechanical chopper for passing or cutting off incident heat, a cooling device for dissipating heat generated in the thermal image sensor or maintaining the thermal image sensor at a specific temperature, an electronic circuit for determining whether an obstacle exists using the thermal signals that have passed through the thermal image sensor, and containing individual ID, a video output unit for converting the output signals of the electronic circuit into video signals, and a wired transmission unit for transmitting video output signals via an existing signal line, or a wireless communication unit for transmitting the output signals of the video output unit through short-distance radio communication.

The radio communication is realized in such a way as to install an antenna on one surface of the side mirror in the form of a microstrip antenna and enable the antenna to communicate with a display device (which is used as a representative of various information display devices) inside the car, thus minimizing aerial resistance and manufacturing costs.

Furthermore, the wireless communication unit uses a short-distance, low-output radio communication technique via a 2.4 GHz low frequency band or an Ultra Wide Band (UWB).

The thermal infrared camera device is assigned an individual encryption ID.

The display device starts a voice service of providing notification of the presence of an obstacle when the obstacle is detected while the car drives at a speed equal to or greater than a predetermined speed.

The thermal infrared camera device may be installed in the one side or both sides of two side mirror members.

If the two thermal infrared cameras are installed in the two side mirror members, stereo video information is extracted and displayed on the screen of the display device.

The side mirror member itself functions as the heat dissipation plate.

The video data, collected from the video output unit, is transmitted through an existing signal line or an additionally deployed signal line via a wired connection.

Dirt that sticks to a protective lens attached to the outside of the thermal infrared camera device is removed using a rotary brush.

The video data, collected from the video output unit, is exchanged with any point inside the car, throughout which a network using a car data transmission and reception protocol is deployed, in a compressed data or original information form via the car data transmission and reception protocol, such as a Controller Area Network (CAN) or Media Oriented Systems Transport (MOST) protocol.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram showing the appearance of a car equipped with a prior art infrared camera device;

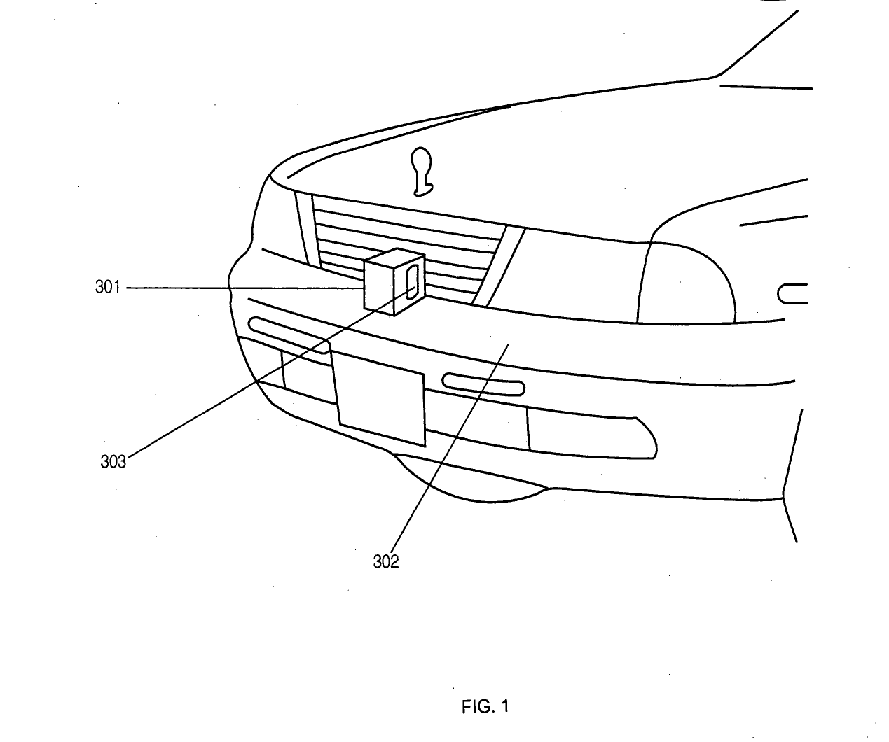

FIG. 2 is a block diagram showing the prior art infrared camera device of FIG. 1;

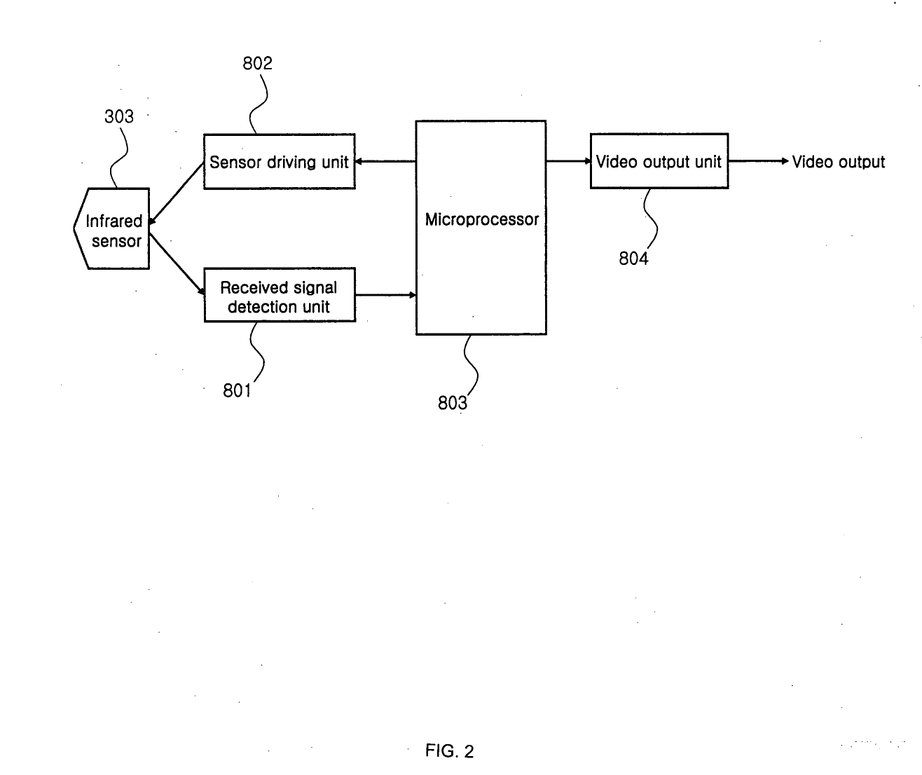

FIG. 3 is a diagram showing the construction of a car side mirror equipped with a thermal infrared camera device according to the present invention; and

FIG. 4 is a block diagram showing the thermal infrared camera device of FIG. 3.

### DESCRIPTION OF THE PREFERRED EMBODIMENTS

Reference now should be made to the drawings, in which the same reference numerals are used throughout the different drawings to designate the same or similar components.

Preferred embodiments of the present invention are described in detail below with reference to the accompanying drawings.

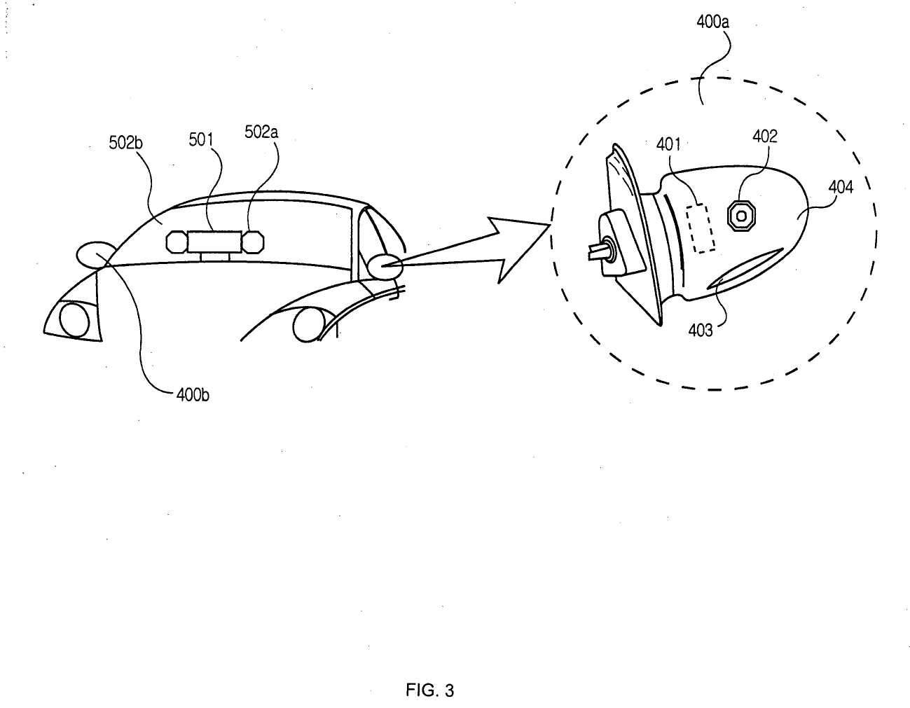

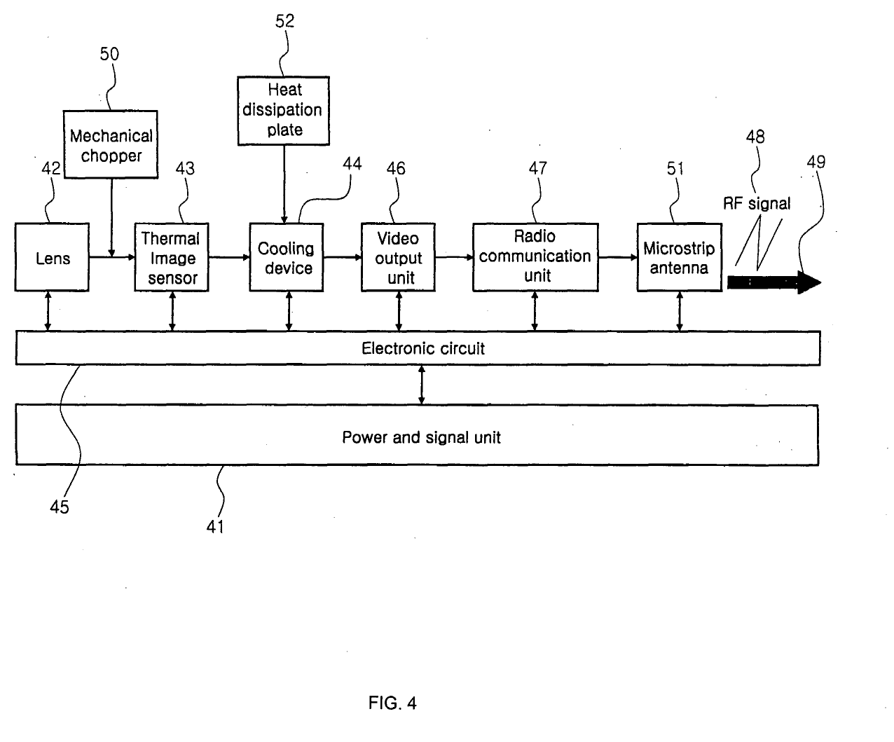

FIG. 3 is a diagram showing the construction of a car side mirror equipped with a thermal infrared camera device according to the present invention, and FIG. 4 is a block diagram showing the thermal infrared camera device of FIG. 3.

As shown in FIGS. 3 and 4, in each of the car side mirrors 400a and 400b equipped with thermal infrared camera devices according to the present invention, a thermal infrared camera 402 is mounted on the front surface of a side mirror member 404, and a microstrip antenna 401 is mounted inside the side mirror member 404. Furthermore, an opening 403 is formed through the side mirror member 404, and dissipates heat that is generated in the heat dissipation plate 52.

In this case, the side mirror itself may function as the heat dissipation plate 52, without requiring a separate opening 403, depending on the amount of emitted heat.

Furthermore, the thermal infrared camera 402 may be mounted in any one side mirror member 404 or in both of the side mirror members 404. Here, if the thermal infrared camera 402 is mounted on both side mirror members 404, it is preferred that three-dimensional (3D) video information be extracted and displayed. In this case, the 3D video information may be represented in the form of graphics, a voice or 3D video.

Meanwhile, it is preferred that power and signals inside the side mirror member 404 be supplied through a power supply line, connected to a power cable inside a car, and a signal line, provided in the display device 501. In this case, it is preferred that the power be connected to a power source that is connected to a car ignition signal.

The thermal infrared camera 402, as shown in FIG. 4, includes a power and signal unit 41, a lens 42, a mechanical chopper (or a shutter) 50, a thermal image sensor 43, a cooling device 44, an electronic circuit 45, a video output unit 46, and a wireless communication unit 47.

The video output unit 46 and the wireless communication unit 47 are directly connected to each other, and transmit generated video signals. In this case, if there is an extra signal line assigned to the side mirror 400a or a signal line is newly deployed in the side mirror 400a, and the video output unit 46 can be connected to an information display device inside the car, the video output unit 46 can receive and transmit signals not via a wireless connection but via a wired connection.

Furthermore, thermal video signals pass through the lens 42, so that the thermal image sensor 43 detects heat emitted from objects in front of the car. In this case, the lens 42 observes a radial region in the forward direction, or generally observes a rectangular region depending on the shape of an imaging element.

The mechanical chopper 50 is used when incident light needs to be passed therethrough or be blocked for each frame according to the characteristics of the thermal image sensor 43.

The cooling device 44 is configured to contain the heat dissipation plate 52 in order to dissipate heat generated in the thermal image sensor 43. In this case, if the cooling device 44 is a thermo-electric cooler and current is made to flow in the opposite direction, the cooling device 44 can perform a warming function, thereby enabling the stable acquisition of images by maintaining the thermal image sensor at a constant temperature. Of course, a separate temperature control circuit for the camera may be additionally used.

Furthermore, it is preferred that the heat dissipation plate 52 be installed inside the opening 403. If necessary, the opening 403 of the side mirror 400a itself may function as the heat dissipation plate 52.

Meanwhile, the electronic circuit 45 determines whether an obstacle exists using the video signals that have passed through the thermal image sensor 43, and has an individual (encryption) ID.

In this case, it is preferred that a temperature detection and current drive unit for adjusting the cooling device 44 be constructed together with the electronic circuit 45.

Furthermore, in order to maintain a set temperature using a circuit, such as a microprocessor existing in the electronic circuit 45, the temperature of the thermal image sensor 43 is maintained and managed by controlling the cooling device 44 using information that is received from the temperature sensor. Furthermore, if necessary, the temperature control may be applied to part or all of the camera, as well as the thermal image sensor 43.

The video output unit 46 functions to receive output signals from the electronic circuit 45 and convert the output signal into standard video signals. In this case, in order to transmit an alarm sound, the video signals may be combined with and transmitted together with voice signals. In greater detail, the video signals include progressive scan-type computer compatible standard signals as well as television standard signals, such as NTSC/PAL/SECAM standard signals.

Furthermore, the wireless communication unit 47 performs short-distance communication of compressing and transmitting video data that is collected from the video output unit 46. In this case, the video data is transmitted to the display device 501, which is installed inside the car and has an individual (encryption) ID identical to that of the electronic circuit 45, through the wireless communication unit 47 via the microstrip antenna 51 in the form of radio frequency signals 48. A wired communication (not shown) is also possible. Here, the display device 501 starts voice service for providing notification of the presence of an obstacle via a warning sound when the obstacle is detected while the car drives at a speed equal to or greater than a predetermined speed.

In this case, the wireless communication unit 47 may use a high frequency band, such as 2.4 GHz band or the Ultra Wide Band (UWB), which is generally used for short-distance, low-output radio communication.

Furthermore, the display device 501 may have an operation mode in which the infrared camera of the present invention is not used, and thus may simply function as the display of a car navigation system. The display may be performed on a Liquid Crystal Display (LCD), which is disposed in the center of a steering wheel, or may be performed on a windshield using a projection method. The representation of information may be performed using an appropriate combination of a car video display system and a car audio system inside the car.

Furthermore, the display device 501 assigns unique numbers to respective thermal infrared cameras 402, which are installed in side mirror members 404, so that the display device 501 can transmit and receive signals only when the unique numbers are input to the decryption module of the display device 501. By doing so, another party finding the mirror can be prevented from mounting the side mirror 400a, equipped with the thermal infrared camera 402, on another car and using it when the side mirror 400a is lost, thereby reducing the possibility of loss of the side mirror 400a equipped with the thermal infrared camera 402.

The display device 501 may manipulate the electronic/optical zoom function and fan tilt function of the thermal infrared camera 402 via a low-speed command channel, which is connected to the thermal infrared camera 402.

Furthermore, dirt that sticks to the lens 42 of the infrared camera 402 may be removed using a rotating brush (not shown).

Moreover, an individual (encryption) ID is generated by encrypting a unique code for each camera, and only a corresponding display device 501 and thermal infrared camera 402 can recognize the corresponding individual (encryption) ID.

When respective thermal infrared cameras 402 are installed in both side mirrors 400a, some of the image processing functions of the electronic circuit 45 of FIG. 4 are provided inside the display device 501, so that 3D video information can be acquired by combining information output from the two thermal infrared cameras 402. As a result, detailed information about the motion of an object, such as a human, a car, or an animal, on a road is provided, and thus an optimal measure can be taken for each situation.

Furthermore, the radio transceiver unit 47 is configured to distinguish right and left cameras from each other using a method such as separate encryption coding methods or frequency separation. Furthermore, the two pieces of information may be separated by increasing the directivity of the antennas.

Here, radio transmission units 502a and 502b, which operate in conjunction with the display device 501 of car equipment, such as a car navigation system inside a car, may be implemented such that they are integrated with the display device 501, or may be implemented in the form of a separate module so that it can be connected to existing AV input terminals.

The operation of the car side mirror 400a equipped with the thermal infrared camera 402 according to the present invention will be described in greater detail below.

First, when the ignition key of a car is turned on, power is applied to the camera 402. Thereafter, when the display device 501 is started through the manipulation of a driver or according to the automated start procedure of the car, encryption synchronization is established through the exchange of encryption keys with the external thermal infrared camera 402 using a start program. In this case, if an encryption code is not valid, an operator is requested to input a valid encryption code.

Thereafter, when the entire start procedure is completed, preparations for the reception and display of video information have been made. Accordingly, if the camera has an image processing function, the camera is responsible for necessary image processing. If an internal device of the car has an image processing function, the internal device is responsible for necessary image processing.

Thereafter, the thermal image sensor 43 detects a thermal spectrum, radiated from an object in front of the car, through the lens 42. In this case, heat emitted from the thermal image sensor 43 is absorbed by the cooling device 44, and heat radiated from the heat dissipation plate 52 is dissipated through the opening 403 of the side mirror member 404. In this case, the side mirror 400a itself may replace the heat dissipation plate 52.

Thereafter, the electronic circuit 45 detects an object, issues a warning sound, and outputs this output signal through the video output unit 46.

Now, video data collected from the video output unit 46 is transferred to an information display inside the car via the radio transceiver unit 47 in a short-distance radio communication manner, or via the wired cable 49. Here, the radio transceiver unit 47 transmits video to the radio transceiver units 502a and 502b of the display device 501 via the microstrip antenna 401. Meanwhile, if thermal infrared cameras 402 are installed in two side mirrors 400a and 400b and two sets of video information are simultaneously acquired, 3D information can be extracted, in which case an image processing device is installed in the display device 501 or inside the car. In this case, the video data collected from the video output unit 46 can be received and transmitted from and to any point inside the car, throughout which a network using a car data transmission and reception protocol (not shown), such as CAN/MOST, is deployed, in a compressed data or original information form. Command information for the control of the camera may also be transmitted.

Furthermore, if the thermal infrared cameras 402 are installed in both side mirrors, the two cameras 402 are spaced apart from each other, unlike a prior art camera, which is mounted on a bumper, therefore more accurate 3D video information can be acquired.

As described above, when a radio video transmission method is used, the car side mirror 400a equipped with the thermal infrared camera 402 according to the present invention can be implemented using only a power supply line that exists for a car side mirror. In contrast, when a wired video transmission method is used, a signal line for the control of a side mirror is additionally deployed, and is conveniently connected to the side mirror 400a equipped with the thermal infrared camera 402. In both cases, the burden of installing an infrared camera on a bumper can be eliminated. Of course, such a side mirror may be implemented using a Power Line Communication (PLC) method.

Furthermore, according to the present invention, the thermal infrared camera and the thermal image sensor are installed using only a power supply line that is disposed in the side mirror, or only an existing signal line, so that the installation and removal of the parts is easy. Moreover, the camera can exchange video and control signals with the display device inside the car using a radio transceiver module, such as a Bluetooth module, so that the camera device can be installed simply by replacing a side mirror module, including a camera device, without additionally changing the structure of the car.

Additionally, since encryption is applied to the display device and the thermal infrared camera, the camera device can be used with minimal risk of theft.

As described above, the thermal infrared camera according to the present invention is installed in the car side mirror, so that the thermal infrared camera can be installed in the side mirror member at low cost without incurring high expenses. Furthermore, since even invisible objects can be viewed using the display device, a driver can drive a car in foggy weather or at night, thereby significantly reducing the traffic accident rate. Furthermore, in the case where video information is transmitted to an information display device using a radio transceiver module, the installation and removal of the device are facilitated.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A car side mirror equipped with a thermal infrared camera, comprising:
a thermal infrared camera device comprising a thermal image sensor for receiving thermal infrared light signals, an electronic circuit for determining whether an obstacle exists in front of a car using thermal signals that have passed through the thermal image sensor, and containing an individual Identification (ID), and a video output unit for converting output signals of the electronic circuit into video signals, the thermal infrared camera device being attached to a front surface of a side mirror member and photographing one or more objects in a desired direction;
a video signal transmission device for transmitting the video signals, acquired through the photographing of the thermal infrared camera device, to a display device inside the car;
a power unit for supplying power to the thermal infrared camera device and the video signal transmission device.

2. The car side mirror as set forth in claim 1, wherein the thermal infrared camera device further comprises a cooling device that is configured to include a heat dissipation plate so as to dissipate heat generated in the thermal image sensor, and the side mirror member further comprises an opening that is formed through the front surface of the side mirror member so as to dissipate heat generated in the heat dissipation plate.

3. The car side mirror as set forth in claim 1, wherein the video signal transmission device comprises a radio communication unit, which converts signals output from the video output unit into radio communication signals, and a microstrip antenna.

4. The car side mirror as set forth in claim 1, wherein the video signal transmission device transmits the video signals, acquired through the photographing of the thermal infrared camera, to the display device inside the car via a wired connection.

5. The car side mirror as set forth in claim 1, wherein the display device starts a voice service of providing notification of presence of an obstacle when the obstacle is detected while the car drives at a speed equal to or greater than a predetermined speed.

6. The car side mirror as set forth in claim 1, wherein the thermal infrared camera device is installed in the one side or both sides of the two side mirror members.

7. The car side mirror as set forth in claim 6, wherein, when the two thermal infrared cameras are installed in the two side mirror members, stereo video information is extracted and displayed on a screen of the display device.

8. The car side mirror as set forth in claim 2, wherein the side mirror member itself functions as the heat dissipation plate.

9. The car side mirror as set forth in claim 1, further comprising a brush for removing dirt that sticks to the thermal infrared camera device.

10. The car side mirror as set forth in claim 1, wherein the individual ID is encrypted.

11. The car side mirror as set forth in claim 1, wherein the video information, collected from the video output unit, is exchanged with any point inside the car, throughout which a network for a car data transmission and reception protocol is deployed, in a compressed data or original information form.
